(19) United States
(12) Patent Application Publication
(10) Pub. No.: US 2008/0012817 A1
(43) Pub. Date: Jan. 17, 2008

(54) Driving method capable of generating AC-converting signals for a display panel by setting pin levels of driving circuits and related apparatus

(76) Inventors: I-Min Chen, Miaoli County (TW); Feng-Jung Kuo, Taipei County (TW); Sheng-Yuan Chu, Taipei County (TW); Way-Guo Tseng, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/309,870

(22) Filed: Oct. 16, 2006

(30) Foreign Application Priority Data
Jul. 13, 2006 (TW) 095125634

(51) Int. Cl. G09G 3/36

(52) U.S. Cl. 345/100; 345/89; 345/98

(57) ABSTRACT

A driving method for a display panel generates AC-converting signals by setting pin levels of a driving circuit. Data pins of a driving circuit operating in a common mode are set according to a frequency-dividing ratio. Based on a line latch pulse signal and the data pins of the driving circuit operating in common mode, a corresponding AC-converting signal is generated and sent to another driving circuit operating in segment mode or common mode.

### BACKGROUND OF THE INVENTION

1. Field of the Invention

The present invention relates to a driving method for a display panel and related apparatus, and more particularly, to a driving method capable of generating AC-converting signals for a display panel by setting pin levels of an STN driving circuit and related apparatus.

2. Description of the Prior Art

With rapid development in the electronic data industry, the applications and demands for liquid crystal display (LCD) devices have also increased. Liquid crystal material provides incident light with different degrees of reflection or refraction when the liquid crystal molecules change orientation. An LCD device can thus display colorful images by controlling light transmittance provided by the liquid crystal material. Based on the driving methods, LCD devices can be categorized into static, simple matrix and active matrix types. Simple matrix LCD devices, also known as passive LCD devices, include twisted nematic (TN) and super twisted nematic (STN) LCD devices. Active matrix LCD devices include thin film transistor (TFT) and metal/insulator/metal (MIM) LCD devices.

The orientation of liquid crystal molecules can change in different ways when an LCD device adopts various driving methods. Therefore, LCD devices operative based on different driving methods provide discriminating performances in viewing angle, color, contrast or brightness, and thus exceed in certain applications particularly. For example, the active TFT LCD devices can provide better display quality by controlling each pixel unit of the display panel using a respective TFT switch. Therefore, although the pixel units of the display panel may have different reaction speeds in response to an applied electric field, data written into the pixel units at different locations on the display panel is not affected. However, the active TFT LCD devices have complicated structures and are thus more suitable for large-size or high-resolution applications, such as notebook computers, flat panel televisions, global positioning systems (GPS), digital cameras and LCD projectors. On the other hand, the passive TN and STN LCD devices are driven based on an applied electric field. If the display panel is very large, the pixel units at the center of the display panel may not be able to respond to the variations in the applied electric field in time, and the display quality will be influenced. However, the passive TN and STN LCD devices have simple structures and are thus more suitable for small-size or low-resolution applications, such as electronic dictionaries, mobile phones, personal digital assistants (PDA), and electronic sphygmomanometers.

Reference is made to FIG. 1 for a diagram of a prior art STN LCD device 10. The LCD device 10 includes a controller 11, a signal generator 12, driving circuits 13 and 14, and an LCD panel 15. In order to avoid permanent polarization of liquid crystal material, voltages with positive and negative polarities are applied to an LCD device in an alternating manner based on an inversion period controlled by an AC-converting signal FR. The driving circuits 13 and 14 are coupled to the LCD panel 15 and the signal generator 12. The driving circuit 13 outputs an X driving signal Vx to the LCD panel 15 based on the AC-converting signal FR and a line latch pulse signal LP. The driving circuit 14 outputs a Y driving signal Vy to the LCD panel 15 based on the AC-converting signal FR, the line latch pulse signal LP, and a frame start pulse signal FSP. The signal generator 12 includes a frequency divider 16 capable of receiving the line latch pulse signal LP from the controller 11, generating the corresponding AC-converting signal FR by frequency-dividing the line latch pulse signal LP based on the polarity inversion frequency required for driving the LCD panel 15, and outputting the AC-converting signal FR to the driving circuits 13 and 14. The prior art LCD device 10 is complicated since the signal generator 12 is required for generating the appropriate AC-converting signal FR for the driving circuits 13 and 14. Also, the AC-converting signal FR cannot be adjusted flexibly since the frequency divider 16 of the signal generator 12 only provides a constant frequency-dividing ratio.

Reference is made to FIG. 2 for a diagram of another prior art STN LCD device 20. The LCD device 20 includes the controller 11, a signal generator 22, the driving circuits 13 and 14, and the LCD panel 15. The LCD device 20 differs from the LCD device 10 in that the signal generator 22 of the LCD device 20 includes a frequency divider 26 and a dip switch 28. The frequency divider 26 of the signal generator 22 can also receive the line latch pulse signal LP from the controller 11, generate the corresponding AC-converting signal FR by frequency-dividing the line latch pulse signal LP based on the settings of the dip switch 28, and output the AC-converting signal FR to the driving circuits 13 and 14. Therefore, the driving circuit 13 can also output an X driving signal Vx to the LCD panel 15 based on the AC-converting signal FR and the line latch pulse signal LP. The driving circuit 14 can also output a Y driving signal Vy to the LCD panel 15 based on the AC-converting signal FR, the line latch pulse signal LP, and the frame start pulse signal FSP. In the prior art LCD device 20, the AC-converting signal FR can be adjusted by setting the frequency-dividing ratio using the dip switch 28. However, the signal generator 22 still complicates the system.

Reference is made to FIG. 3 for a diagram of another prior art STN LCD device 30. The LCD device 30 includes a controller 31, the driving circuits 13 and 14, and the LCD panel 15. Unlike the LCD devices 20 and 30 that generate the AC-converting signal FR using the external signal generator 12 or 22, the LCD device 30 calculates the AC-converting signal FR based on the line latch pulse signal LP using software, and outputs the AC-converting signal FR to the driving circuits 13 and 14. The hardware of the LCD device 30 can thus be reduced. However, internal programs have to be implemented for calculating the correct AC-converting signal FR, making it more difficult to design the controller 31.

### SUMMARY OF THE INVENTION

The present invention provides a driving method which generates AC-converting signals for a display panel by setting pin levels of an STN driving circuit comprising setting an S/C pin of a first STN driving circuit to a first level for operating the first STN driving circuit in a segment mode; setting levels of a plurality of data pins of the first STN driving circuit according to images to be displayed by a display panel; the first STN driving circuit outputting a first driving signal to the display panel based on an AC-converting signal and the levels of the data pins of the first STN driving circuit; setting an S/C pin of a second STN driving circuit to a second level for operating the second STN driving circuit in a common mode; setting levels of a plurality of data pins of the second STN driving circuit and generating the AC-converting signal based on a line latch pulse signal and the levels of the data pins of the second STN driving circuit; and the second STN driving circuit outputting a second driving signal to the display panel based on the AC-converting signal.

The present invention also provides an LCD device which generates AC-converting signals by setting pin levels comprising an LCD panel for displaying images based on a first driving signal and a second driving signal; a first STN driving circuit coupled to the LCD panel and operating in a segment mode, wherein the first STN driving circuit includes a plurality of data pins whose levels are set according to images to be displayed by the LCD panel, and generates the first driving signal based on an AC-converting signal and the levels of the plurality of data pins of the first STN driving circuit; and a second STN driving circuit coupled to the LCD display panel and operating in a common mode, wherein the second STN driving circuit includes a plurality of data pins whose levels are set according to a frequency-dividing ratio, generates the AC-converting signal based on a line latch pulse signal and the levels of the plurality of data pins of the second STN driving circuit, and generates the second driving signal based on the AC-converting signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a prior art STN LCD device.

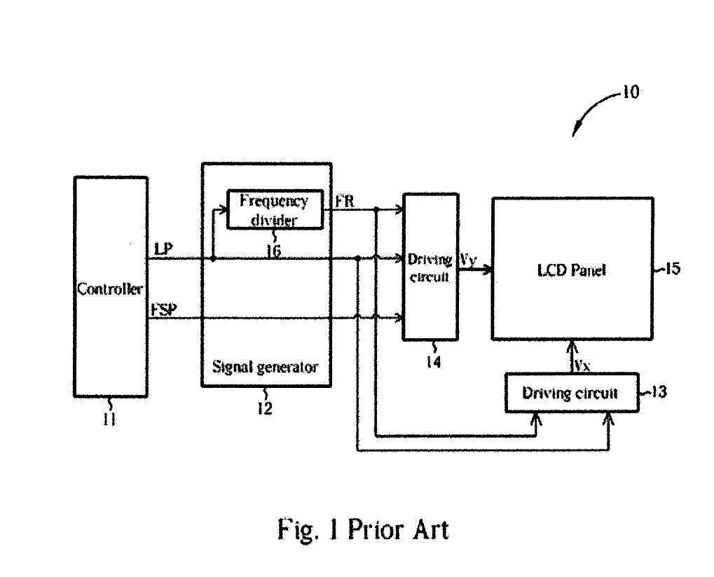

FIG. 2 is a diagram of another prior art STN LCD device.

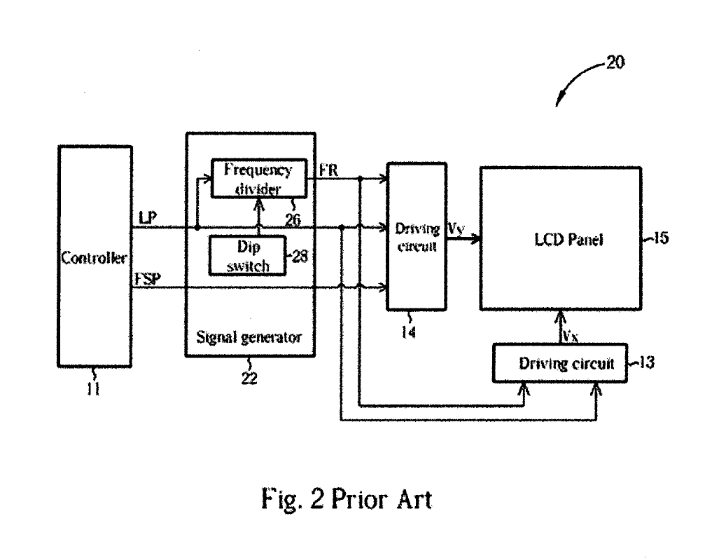

FIG. 3 is a diagram of another prior art STN LCD device.

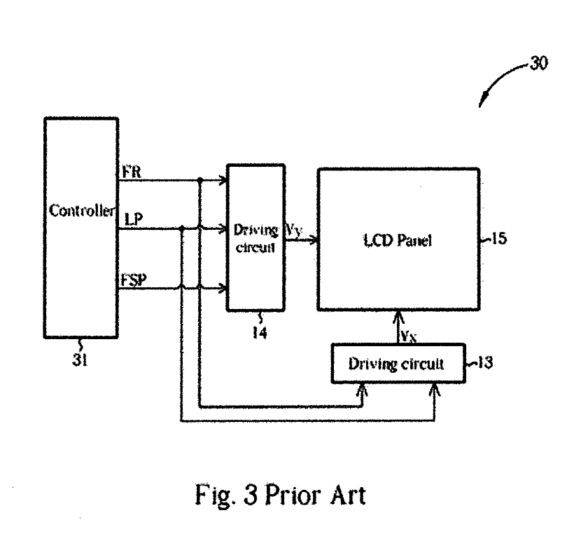

FIG. 4 is a diagram of an STN LCD device according to the present invention.

FIG. 5 is a functional diagram of a driving circuit according to the present invention.

FIG. 6 is a signal diagram illustrating the AC-converting signal generated in the present invention.

FIG. 7 is a flowchart illustrating a method for driving an STN LCD panel according to the present invention.

### DETAILED DESCRIPTION

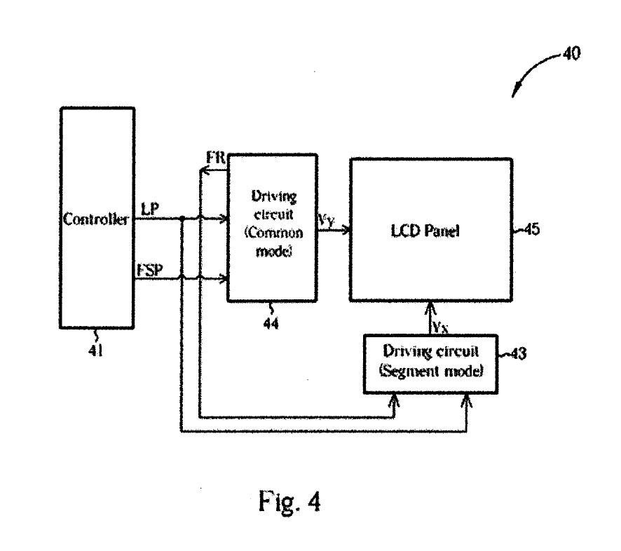

Reference is made to FIG. 4 for a diagram of an STN LCD device 40 according to the present invention. The LCD device 40 includes a controller 41, two driving circuits 43 and 44, and an LCD panel 45. The controller 41 can include a microprocessor unit (MPU) or other types of controllers capable of providing a line latch pulse signal LP and a frame start pulse signal FSP for operating the driving circuits 43 and 44. The driving circuit 43 outputs an X driving signal Vx to the LCD panel 45 based on an AC-converting signal FR and the line latch pulse signal LP. The driving circuit 44 outputs a Y driving signal Vy to the LCD panel 45 based on the AC-converting signal FR, the line latch pulse signal LP, and the frame start pulse signal FSP. In the LCD device 40, the driving circuit 44 receives the line latch pulse signal LP from the controller 41, generates for itself the AC-converting signal FR based on the line latch pulse signal LP and the settings of its pins, and outputs the AC-converting signal FR to the driving circuit 43. Normally, the FR pin of a driving circuit is set so that the driving circuit operates in an input mode. In the present invention, the FR pins of the driving circuits can be set so that the driving circuit 43 operates in an input mode and the driving circuit 44 operates in an output mode.

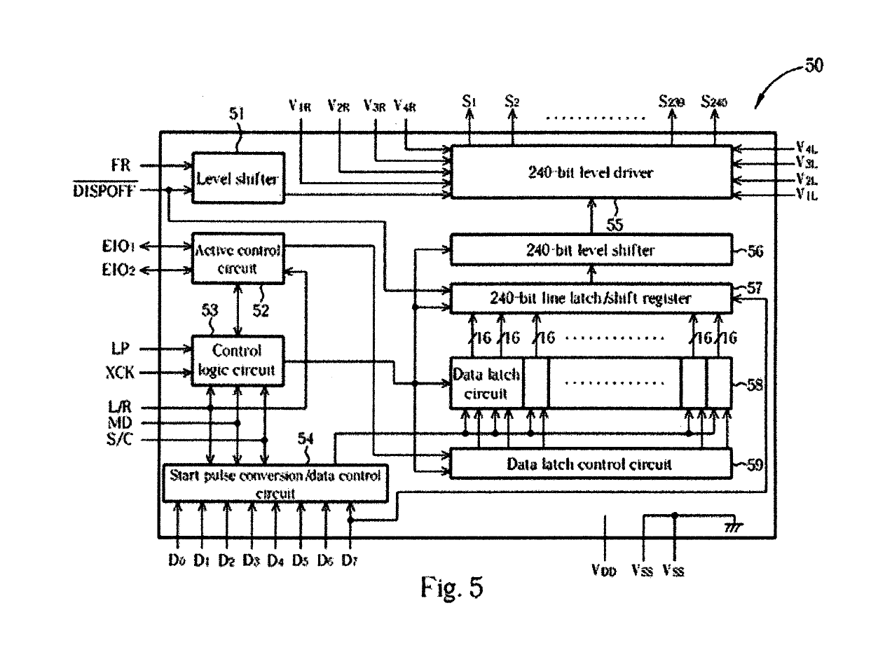

In the LCD device 40, the driving circuits 43 and 44 can include common STN driving circuits widely available in the consumer market. Reference is made to FIG. 5 for a functional diagram of a driving circuit 50 according to the present invention. The driving circuit 50 includes a level shifter 51, an active control circuit 52, a control logic circuit 53, a start pulse conversion/data control circuit 54, a 240-bit level driver 55, a 240-bit level shifter 56, a 240-bit line latch/shift register 57, a data latch circuit 58, and a data latch control circuit 59. In FIG. 5, the pins of the driving circuit 50 and respective signals are designated in the same way. For example, “FR” represents both the FR pin and the signal FR received by the FR pin. The driving circuit 50 includes a plurality of pins, in which the S/C pin (segment mode/common mode selection pin) controls two main operational modes. If the S/C pin is set to a high voltage level, the driving circuit 50 operates in a segment mode. If the S/C pin is set to a low voltage level, the driving circuit 50 operates in a common mode. In the embodiment shown in FIG. 4, the driving circuit 43 adopts a driving circuit 50 operating in the segment mode, and the driving circuit 44 adopts a driving circuit 50 operating in the common mode. The driving circuit 50 illustrates but does not limit the scope of the present invention. The driving circuits 43 and 44 can also adopt other types of driving circuits.

Next, other main pins of the driving circuit 50 will be described. The MD pin is the mode selection pin: when the MD pin is set to a high voltage level, the driving circuit 50 operates in a single mode in which 240 driving voltages S₁-S₂₄₀ can be outputted; when the MD pin is set to a low voltage level, the driving circuit 50 operates in a dual mode in which 120 driving voltages S₁-S₁₂₀ and 120 driving voltages S₁₂₁-S₂₄₀ can be outputted respectively. The L/R pin is the direction selection pin: when the L/R pin is set to a high voltage level, data is outputted in a sequence from S₁ to S₂₄₀; when the L/R pin is set to a low voltage level, data is outputted in a sequence from S₂₄₀ to S₁. The XCK pin is the clock input pin: in the segment mode, the driving circuit 50 accesses data at the falling edges of the clock signals received by the XCK pin; in the common mode, the XCK pin is coupled to ground or open-circuited. The LP pin is the latch pulse input pin: in the segment mode, the driving circuit 50 latches data at the falling edges of the signals received by the LP pin: in the common mode, the driving circuit 50 shifts data at the falling edges of the signals received by the LP pin. The D0-D7 pins are the data pins: in the segment mode, the driving circuit 50 set the voltage levels of the D0-D7 pins according to display images; in the common mode, the D0-D7 pins are not required. Therefore, the D0-D7 pins are coupled to the same bias voltage (such as ground level) in order to prevent from having a floating voltage level and influencing the operations of the driving circuit 50 in the common mode. The FR pin is used for receiving the AC-converting signal FR corresponding to the polarity inversion period of the driving voltages. The V_{DD}, V_{SS}, V_{1R}-V_{4R} and V_{1L}-V_{4L} pins are power supply pins for receiving bias voltages required for operating the driving circuit 50. The EIO1 and EUO2 pins are input/output pins for chip selection. The D̅I̅S̅P̅O̅F̅F̅ pin is the output deselect pin.

The driving circuit 50 shown in FIG. 5 illustrates the structure of a common STN driving circuit widely available in the consumer market. The operations of each device is well known to those skilled in the art and will not be explained in more detail. Though the driving circuit 50 can provide different amounts of output voltages based on different designs or single/dual modes, a driving circuit 50 operating in the segment mode (such as the driving circuit 43) and a driving circuit 50 operating in the common mode (such as the driving circuit 44) are used for driving the LCD panel 45, as illustrated in FIG. 4. Since the driving circuit 44 operating in the common mode does not require the data pins D0-D7, the present invention can control frequency division by setting the data pins D0-D7. In the first embodiment of the present invention when a frequency-dividing ratio of 7 is required, the values [D7:D0] of the data pins D0-D7 in the driving circuit 44 can be set to [00000111]. The driving circuit 44 generates a corresponding AC-converting signal FR by frequency-dividing the line latch pulse signal LP based on the settings of the data pins D0-D7, and outputs the AC-converting signal FR to the driving circuit 43. Therefore, excluding the default settings [00000000] and [11111111] of [D7:D0], the first embodiment of the present invention can provide 254 settings corresponding to different frequency-dividing ratio. In addition, in a second embodiment of the present invention, one of the data pins D0-D7 (such as the data pin D7) or other pins (such as the clock input pin XCK) can be used to set the time for performing frequency division. For example, when the values [D7:D0] of the data pins D0-D7 in the driving circuit 44 are set to [10000111] in the second embodiment of the present invention, the driving circuit 44 performs frequency division with a frequency-dividing ratio 7 at the rising edges of the line latch pulse signal LP; when the values [D7:D0] of the data pins D0-D7 in the driving circuit 44 are set to [00000111] in the second embodiment of the present invention, the driving circuit 44 performs frequency division with a frequency-dividing ratio 7 at the falling edges of the line latch pulse signal LP. Therefore, excluding the default settings [00000000] and [11111111] of [D7:D0], the second embodiment of the present invention can provide 127 settings corresponding to different frequency-dividing ratio.

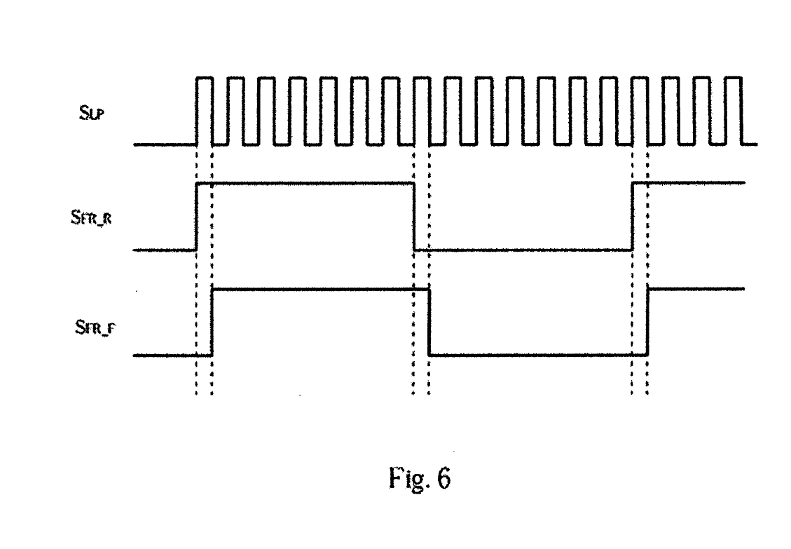

Reference is made to FIG. 6 for a signal diagram illustrating the AC-converting signal generated in the second embodiment of the present invention. In FIG. 6, waveform S_{LP} represents the line latch pulse signal LP outputted by the controller 41, waveform S_{FR}_{_{—}}_{R} represents an AC-converting signal generated when the values [D7:D0] of the data pins D0-D7 are set to [10000111], and waveform S_{FR}_{_{—}}_{F} represents an AC-converting signal generated when the values [D7:D0] of the data pins D0-D7 are set to [00000111].

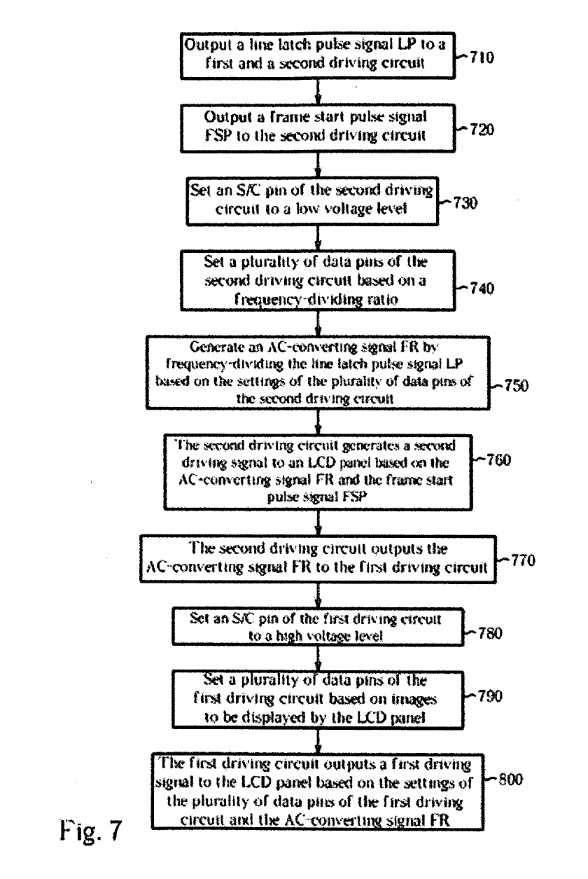

Reference is made to FIG. 7 for a flowchart illustrating a method for driving an STN LCD panel according to the present invention. The flowchart in FIG. 7 includes the following steps:

Step 710: output a line latch pulse signal LP to a first and a second driving circuit.

Step 720: output a frame start pulse signal FSP to the second driving circuit.

Step 730: set an S/C pin of the second driving circuit to a low voltage level for operating the second driving circuit in a common mode.

Step 740: set a plurality of data pins of the second driving circuit based on a frequency-dividing ratio.

Step 750: generate an AC-converting signal FR by frequency-dividing the line latch pulse signal LP based on the settings of the plurality of data pins of the second driving circuit.

Step 760: the second driving circuit generates a second driving signal to an LCD panel based on the AC-converting signal FR and the frame start pulse signal FSP.

Step 770: the second driving circuit outputs the AC-converting signal FR to the first driving circuit.

Step 780: set an S/C pin of the first driving circuit to a high voltage level for operating the first driving circuit in a segment mode.

Step 790: set a plurality of data pins of the first driving circuit based on images to be displayed by the LCD panel.

Step 800: the first driving circuit outputs a first driving signal to the LCD panel based on the settings of the plurality of data pins of the first driving circuit and the AC-converting signal FR.

In the present invention, the data pins not required in the common mode are used for setting the frequency-dividing ratio or other functions. A driving circuit operating in the common mode can provides AC-converting signals for itself and as well as for another driving circuit operating in the segment mode. Therefore, no extra signal generator or implementations of internal programs in a controller is required. Since the chip size and the pin location of the driving circuit on a liquid crystal module (LCM) do not need to be modified, the present invention will not complicate the entire system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving method capable of generating AC-converting signals for a display panel by setting pin levels of an STN (Super Twisted Nematic) driving circuit comprising:
(a) setting an S/C pin (Segment Mode/Common Mode Selection Pin) of a first STN driving circuit to a first level for operating the first STN driving circuit in a segment mode;
(b) setting levels of a plurality of data pins of the first STN driving circuit according to images to be displayed by a display panel;
(c) the first STN driving circuit outputting a first driving signal to the display panel based on an AC-converting signal and the levels of the data pins of the first STN driving circuit;
(d) setting an S/C pin of a second STN driving circuit to a second level for operating the second STN driving circuit in a common mode;
(e) setting levels of a plurality of data pins of the second STN driving circuit and generating the AC-converting signal based on a line latch pulse signal and the levels of the data pins of the second STN driving circuit; and
(f) the second STN driving circuit outputting a second driving signal to the display panel based on the AC-converting signal.

2. The driving method of claim 1 further comprising: the second STN driving circuit outputting the AC-converting signal to the first STN driving circuit.

3. The driving method of claim 1 further comprising:
generating the line latch pulse signal.

4. The driving method of claim 1 wherein the second STN driving circuit outputs the second driving signal to the display panel based on the AC-converting signal and a frame start pulse signal.

5. The driving method of claim 1 wherein step (e) includes setting the levels of the plurality of data pins of the second STN driving circuit based on a frequency-dividing ratio.

6. The driving method of claim 1 being a method for driving an STN LCD panel.

7. The driving method of claim 1 wherein the first level is a high voltage level and the second level is a low voltage level.

8. The driving method of claim 1 wherein the first level is a low voltage level and the second level is a high voltage level.

9. An LCD device capable of generating AC-converting signals by setting pin levels comprising:
an LCD panel for displaying images based on a first driving signal and a second driving signal;
a first STN driving circuit coupled to the LCD panel and operating in a segment mode, wherein the first STN driving circuit includes a plurality of data pins whose levels are set according to images to be displayed by the LCD panel, and generates the first driving signal based on an AC-converting signal and the levels of the plurality of data pins of the first STN driving circuit; and a second STN driving circuit coupled to the LCD display panel and operating in a common mode, wherein the second STN driving circuit includes a plurality of data pins whose levels are set according to a frequency-dividing ratio, generates the AC-converting signal based on a line latch pulse signal and the levels of the plurality of data pins of the second STN driving circuit, and generates the second driving signal based on the AC-converting signal.

10. The LCD device of claim 9 further comprising:
a controller for generating the line latch pulse signal.

11. The LCD device of claim 10 wherein the controller includes a microprocessor unit (MPU).
